(19) United States
(12) Patent Application Publication
(10) Pub. No.: US 2024/0129052 A1
(43) Pub. Date: Apr. 18, 2024

(54) Sensor Embedded Terminal, Disconnecting Determination Method and Disconnecting Determination Program

(71) Applicant: Nippon Telegraph and Telephone Corporation, Tokyo (JP)

(72) Inventors: Kento Watanabe, Tokyo (JP); Kenichi Matsunaga, Tokyo (JP)

(21) Appl. No.: 18/249,486

(22) PCT Filed: Nov. 12, 2020
(86) PCT No.: PCT/JP2020/042248

§ 371 Date: Apr. 18, 2023

(51) Int. Cl. H04J 3/06; H04W 4/38; H04W 56/00

(52) U.S. Cl. CPC H04J 3/0661; H04W 4/38; H04W 56/001

(57) ABSTRACT

A sensor system includes a sensor terminal and a sensor accommodating terminal The sensor accommodating terminal includes a time stamp adding unit that acquires a time stamp of a reception time of a packet received from the sensor terminal, a memory that stores the time stamp and a time stamp interval, and a disconnection determination unit. The disconnection determination unit calculates a first variance of a plurality of time stamp intervals, calculates a second variance of the plurality of time stamp intervals newly obtained after calculation of the first variance, calculates a ratio of the second variance to the first variance as an evaluation value, and determines whether a reception interval of the packet is normal or abnormal by equal variance determination of the evaluation value.

### CROSS-REFERENCE TO RELATED APPLICATIONS

This application is a national phase entry of PCT Application No. PCT/JP2020/042248, filed on Nov. 12, 2020, which application is hereby incorporated herein by reference.

### TECHNICAL FIELD

The present invention relates to a multi-sensor system that accommodates a large variety of sensors, and particularly relates to determination of disconnection of communication between a sensor terminal and a sensor accommodating terminal.

### BACKGROUND

In the Internet of Things (IoT) society in which all things are connected to a network, a wide variety of sensors that can be connected to each other by wireless communication such as the Internet are distributed on the market. By collecting a large amount of data with these sensors and analyzing the data, useful information for humans is expected to be extracted. Specifically, sensor systems corresponding to various use cases and needs such as healthcare, structure monitoring, and global environment monitoring have been requested and developed.

For example, Non Patent Literature 1 proposes a sensor system in which a sensor accommodating terminal 401 such as a smartphone transfers data from a sensor terminal 400 to a server device 402 as illustrated in FIG. 12. The sensor terminal 400 and the sensor accommodating terminal 401 are connected to each other by short-distance wireless communication, and the sensor accommodating terminal 401 and the server device 402 are connected to each other by medium- to long-distance wired communication or wireless communication.

In collecting data, it is important to ascertain a connection status between the sensor terminal and the sensor accommodating terminal in order to avoid power waste due to data retransmission and unintended operation of the sensor terminal operating in an environment with limited resources. As an index for ascertaining the connection status, a received signal strength indicator (RSSI), a signal to noise ratio (S/N ratio), and the like are used.

It is naturally desirable that all sensor terminals have sufficient quality. However, it is impossible for a manufacturer of a sensor terminal to guarantee sufficient quality in the environments of all users due to various use cases. In addition, it is difficult for a user to check the quality of all the sensor terminals to be used in advance. Therefore, a method of connecting a general-purpose sensor accommodating terminal capable of being connected to a sensor terminal including a wide variety of sensors to a sensor terminal whose function and quality are unknown is fully expected.

The connection state between the sensor terminal and the sensor accommodating terminal depends on the environment according to the use case. In an unstable communication environment, packet loss occurs. Packet loss may occur in various communication protocols. When packet loss occurs, data is usually retransmitted, but data is accumulated in the sensor terminal in parallel. That is, under a connection environment where packet loss frequently occurs, the data accumulation speed is faster than the data transmission speed, and the memory of the sensor terminal becomes tight.

Unlike a situation in which the connection between the sensor terminal and the sensor accommodating terminal is disconnected, in a situation in which packet loss occurs but the state does not shift to the disconnected state, there is a likelihood that a buffer overflow of the sensor terminal will occur unless appropriate memory management is performed. The operation of the sensor terminal when a buffer overflow occurs is undefined, and a serious failure may occur in some cases. Therefore, it is necessary to prevent the buffer overflow from occurring.

In a timeout method used in the related art, connection between a sensor terminal and a sensor accommodating terminal is maintained when the sensor accommodating terminal receives a packet from the sensor terminal at a reception interval that does not exceed a timeout period. However, in such a situation, there is a likelihood that the buffer overflow of the sensor terminal will occur as described above, and packet loss will continuously occur.

### CITATION LIST

### Non Patent Literature

Non Patent Literature 1: Kenichi Matsunaga, Shoichi Oshima, Ahmad Musa, Toshihiko Kondo, Hiroki Morimura, “Proposal of multi-sensor accommodation data collection technology suitable for IoT”, Institute of Electronics, Information and Communication Engineers, Proceedings of the 2016 Society Conference.

### SUMMARY

### Technical Problem

Embodiments of the present invention have been made to solve the above problems, and an object of embodiments of the present invention is to provide a sensor accommodating terminal, a disconnection determination method, and a disconnection determination program capable of reducing a likelihood of a buffer overflow of a sensor terminal and preventing an abnormal operation of the sensor terminal in advance.

### Solution to Problem

According to embodiments of the present invention, there is provided a sensor accommodating terminal including: a communication control unit configured to control communication with a sensor terminal that wirelessly transmits a packet storing sensor data; a time stamp adding unit configured to acquire a time stamp of a reception time of the packet received from the sensor terminal; a memory configured to store the time stamp and a time stamp interval which is a time interval of two consecutive time stamps; a first variance calculation unit configured to calculate a first variance of a plurality of the time stamp intervals; a second variance calculation unit configured to calculate a second variance of the plurality of time stamp intervals newly obtained after calculation of the first variance; an evaluation value calculation unit configured to calculate a ratio of the second variance to the first variance as an evaluation value; and an equal variance determination unit configured to determine whether a reception interval of the packet is normal or abnormal by equal variance determination of the evaluation value.

Further, a configuration example of the sensor accommodating terminal of embodiments of the present invention further includes a clock unit configured to measure time, in which the time stamp adding unit acquires the time stamp on the basis of time information of the clock unit upon receiving a packet from the sensor terminal, the first variance calculation unit calculates the first variance on the basis of a first specified number of the time stamp intervals, the second variance calculation unit calculates the second variance on the basis of a second specified number of the time stamp intervals newly obtained after calculation of the first variance, the equal variance determination unit determines whether the reception interval of the packet is normal or abnormal by comparing the evaluation value with a critical value corresponding to a significance level of an F distribution, and the communication control unit disconnects the connection to the sensor terminal when the reception interval of the packet is determined to be abnormal.

Further, in a configuration example of the sensor accommodating terminal of embodiments of the present invention, the time stamp adding unit stores the latest time stamp and the time stamp intervals corresponding to the second specified number in the memory, and an area of the memory in which the time stamp intervals corresponding to the second specified number are stored has a ring buffer structure.

Further, in a configuration example of the sensor accommodating terminal of embodiments of the present invention, the first variance calculation unit sequentially calculates an average value by using the newly obtained time stamp interval and an average value of the time stamp intervals up to an immediately preceding time to store the average value in the memory, and sequentially calculates the first variance by using the newly obtained time stamp interval, the first variance up to an immediately preceding time, the average value up to an immediately preceding time, and the newly calculated average value to store the first variance in the memory, and the second variance calculation unit calculates the second variance on the basis of the second specified number of the time stamp intervals newly obtained after calculation of the first variance of the first specified number of the time stamp intervals.

Further, in a configuration example of the sensor accommodating terminal of embodiments of the present invention, the second variance calculation unit sequentially calculates an average value by using the newly obtained time stamp interval, an average value of the time stamp intervals up to an immediately preceding time, and an oldest time stamp interval stored in the memory to store the average value in the memory, and sequentially calculates the second variance by using the newly obtained time stamp interval, the second variance up to an immediately preceding time, the average value up to an immediately preceding time, the oldest time stamp interval stored in the memory, and the newly calculated average value to store the second variance in the memory.

Further, in a configuration example of the sensor accommodating terminal of embodiments of the present invention, the first variance calculation unit excludes, from calculation of the first variance, a time stamp interval obtained by receiving packets from the sensor terminal in which a communication state with the sensor accommodating terminal is determined to be abnormal, and calculates the first variance on the basis of a time stamp interval obtained by receiving packets from one or more sensor terminals in which a communication state with the sensor accommodating terminal is determined to be normal.

Further, in a configuration example of the sensor accommodating terminal of embodiments of the present invention, the first variance calculation unit calculates the first variance on the basis of a time stamp interval obtained by receiving packets from a plurality of the sensor terminals.

According to embodiments of the present invention, there is provided a disconnection determination method for determining whether to disconnect connection between a sensor terminal and a sensor accommodating terminal in a sensor system including the sensor terminal configured to wirelessly transmit a packet storing sensor data and the sensor accommodating terminal configured to transmit the sensor data included in the packet to a host device, the disconnection determination method including: a first step of acquiring, by the sensor accommodating terminal, a time stamp of a reception time of a packet received from the sensor terminal; a second step of storing, by the sensor accommodating terminal, the time stamp and a time stamp interval which is a time interval between two consecutive time stamps; a third step of calculating, by the sensor accommodating terminal, a first variance of a plurality of the time stamp intervals; a fourth step of calculating, by the sensor accommodating terminal, a second variance of a plurality of the time stamp intervals newly obtained after calculation of the first variance; a fifth step of calculating, by the sensor accommodating terminal, a ratio of the second variance to the first variance as an evaluation value; and a sixth step of determining, by the sensor accommodating terminal, whether a reception interval of the packet is normal or abnormal by equal variance determination of the evaluation value.

According to embodiments of the present invention, there is provided a disconnection determination program causing a computer to execute each of the above steps.

### Advantageous Effects of Embodiments of Invention

According to embodiments of the present invention, by providing the time stamp adding unit, the memory, the first variance calculation unit, the second variance calculation unit, the evaluation value calculation unit, and the equal variance determination unit in the sensor accommodating terminal, a likelihood of a buffer overflow of the sensor terminal can be reduced, and abnormal operation of the sensor terminal can be prevented in advance. As a result, in embodiments of the present invention, it is possible to improve stability of a sensor system while absorbing differences in communication specifications and designs of various sensor terminals at a low cost on the sensor accommodating terminal side.

### BRIEF DESCRIPTION OF THE DRAWINGS

FIG. 1 is a block diagram illustrating a configuration of a sensor system according to a first embodiment of the present invention.

FIG. 2 is a block diagram illustrating a configuration of a disconnection determination unit of a sensor accommodating terminal according to the first embodiment of the present invention.

FIG. 3 is a schematic diagram illustrating a flow of communication from a sensor terminal to a sensor accommodating terminal according to the first embodiment of the present invention.

FIG. 4 is a diagram illustrating an outline of a disconnection determination by the disconnection determination unit of the sensor accommodating terminal according to the first embodiment of the present invention.

FIG. 5 is a diagram illustrating an example of a change in a reception interval of the sensor accommodating terminal according to the first embodiment of the present invention.

FIG. 6 is a flowchart illustrating operations of a communication control unit, a time stamp adding unit, and the disconnection determination unit of the sensor accommodating terminal according to the first embodiment of the present invention.

FIG. 7 is a diagram illustrating disconnection determination processing by a conventional timeout method and the first embodiment of the present invention.

FIG. 8 is a diagram illustrating a method of storing data in a memory of a sensor accommodating terminal according to a second embodiment of the present invention.

FIG. 9 is a flowchart illustrating operations of a time stamp adding unit, a variance calculation unit, and a reference variance calculation unit of the sensor accommodating terminal according to the second embodiment of the present invention.

FIG. 10 is a flowchart illustrating an operation of a reference variance calculation unit of a sensor accommodating terminal according to a third embodiment of the present invention.

FIG. 11 is a block diagram illustrating a configuration example of a computer that realizes a control unit of the sensor accommodating terminal according to the first to third embodiments of the present invention.

FIG. 12 is a block diagram illustrating a configuration of a conventional sensor system.

### DETAILED DESCRIPTION OF ILLUSTRATIVE EMBODIMENTS

### Principle of Embodiments of Invention

In order to solve the above problems, it is necessary to ascertain a state of connection between a sensor terminal and a sensor accommodating terminal, and appropriately determine whether to continue or disconnect the connection to perform control. This control itself can be performed from either the sensor terminal or the sensor accommodating terminal. However, considering that a wide variety of sensor terminals are connected to the sensor accommodating terminal, it costs less to comprehensively perform control in the sensor accommodating terminal than to perform control in individual sensor terminals. In addition, when control is performed in the sensor accommodating terminal, it is possible to implement a large number of deployed sensor terminals without updating firmware, which is efficient.

Therefore, embodiments of the present invention propose a method for determining and controlling disconnection from a sensor terminal by a sensor accommodating terminal. Communication strength indexes such as an RSSI and an S/N ratio are useful information for performing the disconnection determination. However, there are two problems in using these communication strength indexes. The first problem is that since the communication strength index is a value obtained by the communication circuit, it is necessary to implement a communication strength index acquisition function in the communication circuit.

The second problem is that even if the communication strength index acquisition function is implemented in the communication circuit, it is not always possible to access the information on the communication strength index from the application software side. The reason why the information on the communication strength index cannot be accessed from the application software side is that the information on the communication strength index is deleted by driver software or an operating system (OS). The problem that the necessary information cannot be accessed similarly occurs in the use of the communication packet information.

Bluetooth (registered trademark) Low Energy (BLE) is the most widely used standard for communication between a sensor terminal and a sensor accommodating terminal. In BLE, it is specified that information available for preventing occurrence of a buffer overflow of a sensor terminal is stored in a communication packet.

Specifically, 1-bit information called a more data (MD) flag is stored in a header in a data channel protocol data unit (PDU). The MD flag indicates the presence or absence of data that has not yet been transmitted. The specification of BLE is disclosed in the literature “‘Bluetooth Core Specification v5.1,’ Bluetooth SIG Proprietary, 2019.”

If the MD flag can be used, the presence or absence of the remaining data can be ascertained, and therefore it can be used to avoid a buffer overflow. However, as described above, there is a likelihood that the MD flag will not be able to be accessed from the application side depending on the specifications of the driver software and the OS.

For the above reasons, the present invention proposes a method of performing the disconnection determination for avoiding the buffer overflow of the sensor terminal in the sensor accommodating terminal without using the specific header information of the communication packet.

### First Embodiment

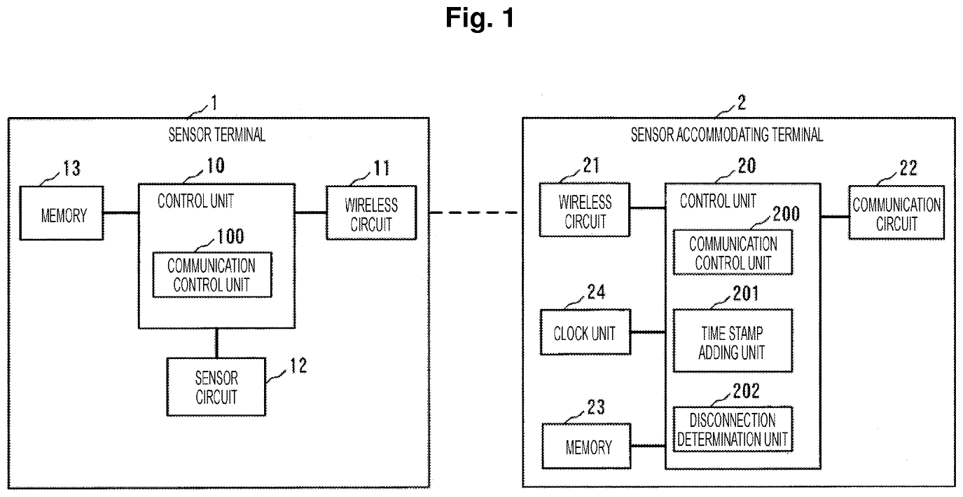

Hereinafter, embodiments of the present invention will be described with reference to the drawings. FIG. 1 is a block diagram illustrating a configuration of a sensor system according to a first embodiment of the present invention. The sensor system includes a sensor terminal 1 that wirelessly transmits a packet storing sensor data, and a sensor accommodating terminal 2 that transmits sensor data included in the packet received from the sensor terminal 1 to a host device such as a server device.

The sensor terminal 1 includes a control unit 10 including a central processing unit (CPU) or a micro control unit (MCU), a wireless circuit 11 controlled by the control unit 10, a sensor circuit 12 that measures a physical quantity, and a memory 13 that stores a program of the control unit 10 and holds data acquired by the sensor circuit 12 until transmission. The control unit 10 includes a communication control unit 100 that controls communication with the sensor accommodating terminal 2.

The sensor accommodating terminal 2 includes a control unit 20 including a CPU or an MCU, a wireless circuit 21 that is controlled by the control unit 20 and performs wireless communication with the sensor terminal 1, a communication circuit 22 that is controlled by the control unit 20 and performs communication with a server device (not illustrated), a memory 23 that stores a program, a time stamp, and a time stamp interval of the control unit 20, and a clock unit 24 that measures time.

The control unit 20 includes a communication control unit 200 that controls communication with the sensor terminal 1 and the server device, a time stamp adding unit 201 that acquires a time stamp of a reception time of a packet received from the sensor terminal 1, and a disconnection determination unit 202 that performs disconnection determination of communication with the sensor terminal 1.

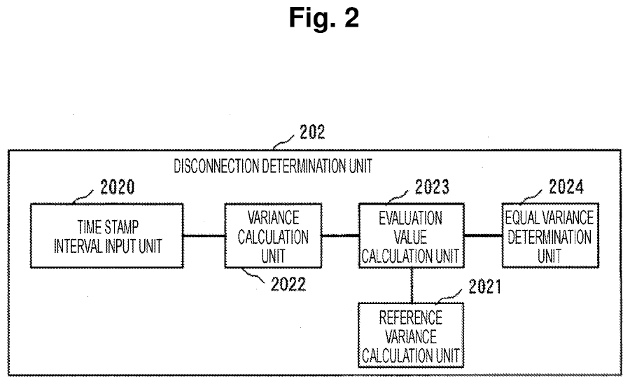

FIG. 2 is a block diagram illustrating a configuration of the disconnection determination unit 202. The disconnection determination unit 202 includes a time stamp interval input unit 2020 that acquires a time stamp interval from the memory 23, a reference variance calculation unit 2021 (first variance calculation unit) that calculates a first variance of a plurality of time stamp intervals as a reference value, a variance calculation unit 2022 (second variance calculation unit) that calculates a second variance of a plurality of time stamp intervals newly obtained after calculation of the first variance, an evaluation value calculation unit 2023 that calculates a ratio of the second variance to the first variance as an evaluation value, and an equal variance determination unit 2024 that determines whether the reception interval of the packet is normal or abnormal by equal variance determination of the evaluation value.

Since the CPU or the MCU constituting the control unit 20 of the sensor accommodating terminal 2 needs to perform calculation processing, it is necessary to select one having high calculation capability. On the other hand, an essential function of the sensor terminal 1 is to acquire data from the sensor circuit 12 and transmit the data to the sensor accommodating terminal 2 by wireless communication. Therefore, the CPU or MCU constituting the control unit 10 of the sensor terminal 1 may have low performance, and there is no problem.

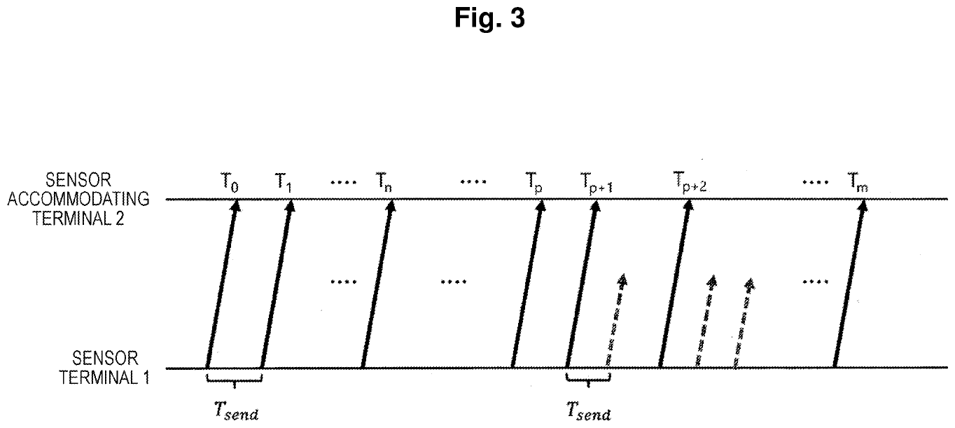

FIG. 3 is a schematic diagram illustrating a flow of communication from the sensor terminal 1 to the sensor accommodating terminal 2 in the present embodiment.

The sensor circuit 12 of the sensor terminal 1 outputs sensor data including information on the measured physical quantity. This sensor data is temporarily stored in the memory 13. The communication control unit wo of the sensor terminal 1 causes the wireless circuit 11 to transmit a packet storing the data acquired from the sensor circuit 12 to the sensor accommodating terminal 2 at a constant cycle T_{send}.

The communication control unit 200 of the sensor accommodating terminal 2 receives the packet transmitted from the sensor terminal 1 via the wireless circuit 21. The clock unit 24 of the sensor accommodating terminal 2 outputs time information of year, month, day, hour, minute, and second. The time stamp adding unit 201 of the sensor accommodating terminal 2 acquires time information (time stamp) upon receiving a packet from the sensor terminal 1 and stores the time information in the memory 23. In FIG. 3, T₀, T₁, . . . , Tₙ, . . . , Tₚ, Tₚ₊₁, Tₚ₊₂, . . . , Tₘ represent time stamps.

An expected value E[dₙ] of a time interval dₙ₋₁=Tₙ−Tₙ₋₁ between the two consecutive time stamps Tₙ₋₁ and Tₙ coincides with a predefined transmission cycle T_{send}. Each time stamp has a potentially random variation component relative to the expected value. Therefore, the distribution of a time interval d of the time stamps can be considered to follow a normal distribution N(T_{send}, σₛₜₐₘₚ²)(σₛₜₐₘₚ² is a variance).

When the communication environment deteriorates, the packet arrival interval is not constant, and thus, it is considered that the expected value and the variance of the time interval of the time stamp change. Therefore, if it is found that the expected value or variance of the time interval has significantly changed from the value in the normal communication environment, it is possible to determine disconnection from the sensor terminal 1.

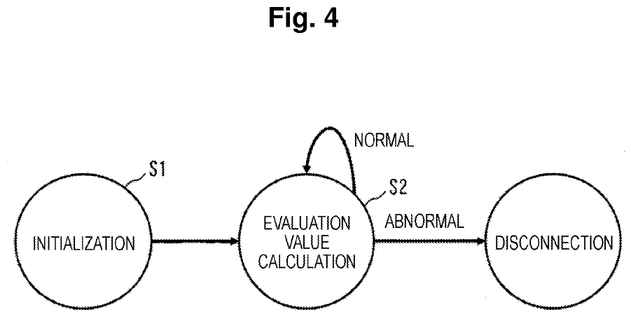

FIG. 4 is a diagram illustrating an outline of the disconnection determination by the disconnection determination unit 202 of the sensor accommodating terminal 2. The disconnection determination is roughly divided into initialization processing (step S1) and evaluation value calculation processing (step S2).

As described above, when the communication environment deteriorates, it is considered that the expected value and the variance of the time interval of the time stamp change, and thus, the expected value and the variance can be used for the disconnection determination.

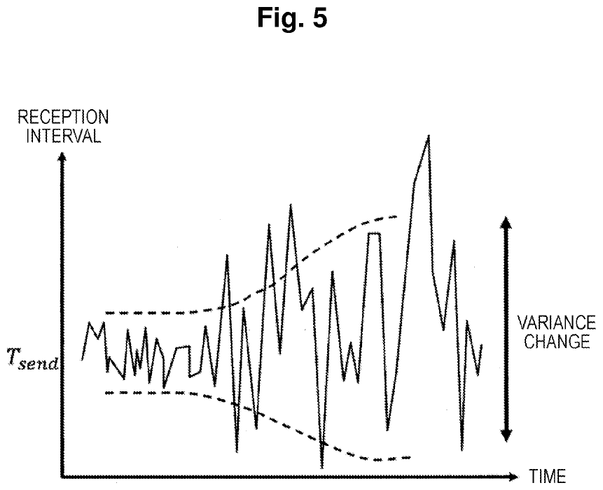

However, there is also a communication protocol that transmits data at intervals shorter than the defined transmission cycle T_{send} when data transfer is delayed due to packet loss or the like. Therefore, as illustrated in FIG. 5, there is a likelihood that the average value of the reception intervals in the sensor accommodating terminal 2 will not change even if the communication environment deteriorates.

For example, according to BLE, which is a communication protocol widely used in sensor terminals, a sensor terminal performs communication only at a specified connection interval at the time of connection with a sensor accommodating terminal, and attempts transmission at a connection interval immediately after occurrence of an event of transmitting data. This connection interval is generally shorter than the data transmission cycle T_{send}. When data transmission fails, the sensor terminal attempts retransmission at the next connection interval. Therefore, there is a likelihood that the sensor accommodating terminal will record a time stamp interval shorter than T_{send}.

Therefore, in the present embodiment, the disconnection determination is performed as follows using only the variance instead of the expected value of the time stamp interval.

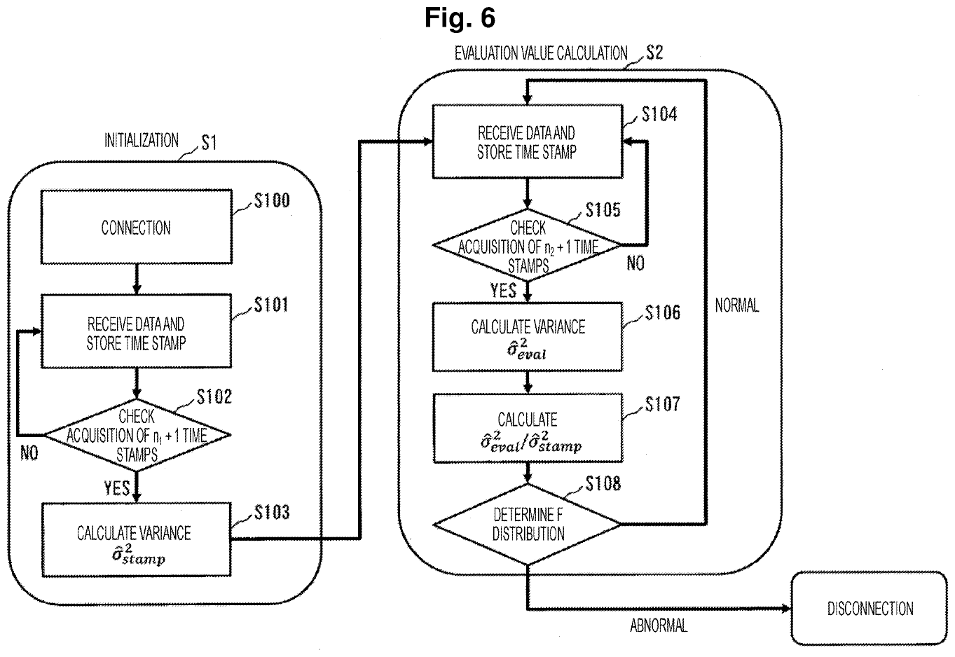

FIG. 6 is a flowchart illustrating operations of the communication control unit 200, the time stamp adding unit 201, and the disconnection determination unit 202 of the sensor accommodating terminal 2.

When the connection with the sensor terminal 1 is established (step S100 in FIG. 6), the communication control unit 200 receives a packet transmitted from the sensor terminal 1 and extracts sensor data from the packet. The communication control unit 200 stores the extracted sensor data in a packet for communication with the server device and transmits the packet from the communication circuit 22 to the server device.

The time stamp adding unit 201 acquires a time stamp upon receiving a packet from the sensor terminal 1 and stores the time stamp in the memory 23. In addition, the time stamp adding unit 201 calculates a time interval between the acquired time stamp and the previous time stamp and stores the time interval in the memory 23 (step S101 in FIG. 6).

When n₁+1(n₁ is a first specified number, and is an integer of 2 or more) time stamps are stored in the memory 23 (YES in step S102 in FIG. 6), the reference variance calculation unit 2021 of the disconnection determination unit 202 acquires a time stamp interval from the memory 23. Here, in order to distinguish from a time stamp interval for evaluation value calculation to be described later, n₁ time stamp intervals obtained from n₁+1 time stamps are denoted by d_{1,i} (i=1, . . . , n₁).

As initialization processing of the disconnection determination, the reference variance calculation unit 2021 calculates a variance σₛₜₐₘₚ²-hat for n₁ time stamp intervals d_{1,i} as in the following expression (step S103 in FIG. 6).

$$\begin{matrix}Equation 1 & \\ {\hat{σ}}_{s tamp}^{2} = \frac{1}{{n}_{1} - 1} \{ {\sum }_{i = 1}^{{n}_{1}} {d}_{1 , i}^{2} - \frac{{( {\sum }_{l = 1}^{{n}_{1}} {d}_{1 , i} )}^{2}}{{n}_{1}} \} & ( 1 )\end{matrix}$$

Similarly to step S101, the time stamp adding unit 201 acquires a time stamp upon receiving a packet from the sensor terminal 1 and stores the time stamp in the memory 23. In addition, the time stamp adding unit 201 calculates the interval between the acquired time stamp and the previous time stamp and stores the interval in the memory 23 (step S104 in FIG. 6).

When n₂+1 (n₂ is a second specified number, and is an integer of 2 or more) time stamps different from the n₁+1 time stamps are stored in the memory 23 (YES in step S105 in FIG. 6), the time stamp interval input unit 2020 acquires a time stamp interval from the memory 23. Here, n₂ time stamp intervals obtained from n₂+1 time stamps are denoted by d_{2,i} (i=1, . . . , n₂).

The variance calculation unit 2022 calculates a variance σₑᵥₐₗ²-hat for the n₂ time stamp intervals d_{2,i} as in the following expression (step S106 in FIG. 6).

$$\begin{matrix}Equation 2 & \\ {\hat{σ}}_{e v a l}^{2} = \frac{1}{{n}_{2} - 1} \{ {\sum }_{i = 1}^{{n}_{2}} {d}_{2 , i}^{2} - \frac{{( {\sum }_{i = 1}^{{n}_{2}} {d}_{2 , i} )}^{2}}{{n}_{2}} \} & ( 2 )\end{matrix}$$

The evaluation value calculation unit 2023 calculates a ratio σₑᵥₐₗ²-hat/σₛₜₐₘₚ²-hat of the variance σₑᵥₐₗ²-hat to the variance σₛₜₐₘₚ²-hat as an evaluation value (step S107 in FIG. 6).

The equal variance determination unit 2024 determines whether the evaluation value σₑᵥₐₗ²-hat/σₛₜₐₘₚ²-hat is equal to or greater than a critical value F(n₂-1, n₁-1; α) corresponding to a significance level α of an F distribution of a degree of freedom (n₂-1, n₁-1) as in the following expression (step S108 in FIG. 6).

$$\begin{matrix}Equation 3 & \\ \frac{{\hat{σ}}_{eval}^{2}}{{\hat{σ}}_{s tamp}^{2}} \geq F ( {n}_{2} - 1 , {n}_{1} - 1 ; α ) & ( 3 )\end{matrix}$$

When Expression (3) is satisfied, the equal variance determination unit 2024 determines that σₑᵥₐₗ²-hat has changed with respect to the variance σₛₜₐₘₚ²-hat, and determines that the packet reception interval is abnormal. When it is determined to be abnormal, the communication control unit 200 disconnects the connection to the sensor terminal 1.

In addition, when the evaluation value σₑᵥₐₗ²-hat/σₛₜₐₘₚ²-hat is smaller than F(n₂-1, n₁-1; α) and Expression (3) is not satisfied, the equal variance determination unit 2024 determines that the variances σₛₜₐₘₚ²-hat and σₑᵥₐₗ²-hat are equal and the packet reception interval is normal. In a normal case, the connection with the sensor terminal 1 is maintained, and the processing in and after step S104 is performed for a new time stamp.

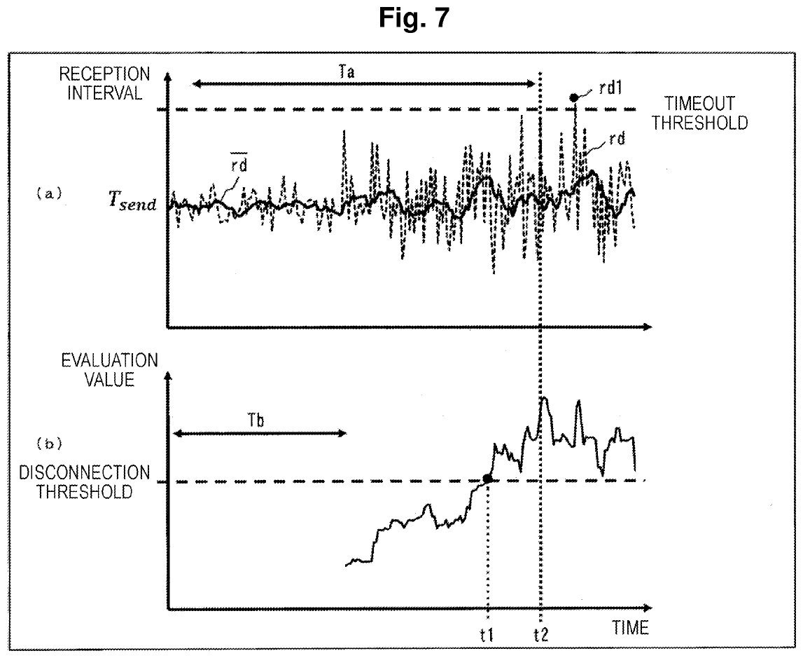

According to the above method, in the present embodiment, a significant change in σₑᵥₐₗ²-hat with respect to the variance σₛₜₐₘₚ²-hat in the normal state can be recognized, and the disconnection determination can be performed at an arbitrary level of the user. Here, in order to perform disconnection determination with a small temporal loss after calculation of the variance σₛₜₐₘₚ²-hat which is a reference value, it is preferable to set n₁≥n₂.
a of FIG. 7 illustrates an example of disconnection determination processing by a conventional timeout method. rd represents a reception interval in the sensor accommodating terminal, and rd-bar represents an average value of the reception intervals. In the example in a of FIG. 7, untransmitted data is accumulated in the buffer of the sensor terminal in a period Ta.

In the timeout method, an appropriate threshold value needs to be set, and there is a likelihood that frequent disconnection or an event that disconnection cannot be performed will occur. As a result, since the sensor terminal and the sensor accommodating terminal are not disconnected, a buffer overflow of the sensor terminal occurs at time t2. Due to the occurrence of the buffer overflow, a timeout cannot be made in time as at point rdi, and there is a likelihood that the buffer overflow will occur and an abnormal operation will occur.

On the other hand, b of FIG. 7 illustrates an example of disconnection determination processing by the present embodiment. Tb is a period for calculating the variance σₛₜₐₘₚ²-hat. In the present embodiment, when the evaluation value becomes equal to or greater than a threshold value F(n₂-1, n₁-1; α) at time t₁, the communication control unit 200 of the sensor accommodating terminal 2 disconnects the connection to the sensor terminal 1.

In the present embodiment, by performing disconnection on the basis of the equal variance determination result of the evaluation value, it is possible to identify the instability of the communication environment from the variation in the reception intervals and perform the disconnection processing at timing earlier than the occurrence of the buffer overflow of the sensor terminal 1. Therefore, abnormal operation of the sensor terminal 1 can be prevented in advance.

In addition, the sensor terminal 1 is generally in a connection standby state after disconnection, and is connected to the sensor accommodating terminal 2 again after the connection standby state. When the sensor terminal 1 enters the connection standby state, the buffer is cleared. Therefore, buffer overflow does not occur at the timing of occurrence in the related art, and the sensor terminal 1 can be continuously operated. As a result, in the present embodiment, it is possible to improve stability of a sensor system while absorbing differences in communication specifications and designs of various sensor terminals 1 at a low cost on the sensor accommodating terminal 2 side.

The present embodiment is particularly suitable in a communication protocol in which retransmission, that is, burst transmission, is performed at a higher speed than a specified transmission cycle when there is untransmitted data.

### Second Embodiment

Subsequently, a second embodiment of the present invention will be described. The present embodiment describes a method of reducing the used memory amount in the first embodiment. The configurations of the sensor terminal 1 and the sensor accommodating terminal 2 in the present embodiment are the same as those in the first embodiment.

In the first embodiment, it is necessary to accumulate the time stamp intervals for calculating the reference value and the evaluation value, which consumes the memory 23. Since the capacity of the memory 23 of the sensor accommodating terminal 2 is generally not abundant and limited, it is not possible to continue to accumulate all of the time stamps and the time stamp intervals. Therefore, the present embodiment proposes a method of saving the used memory amount.

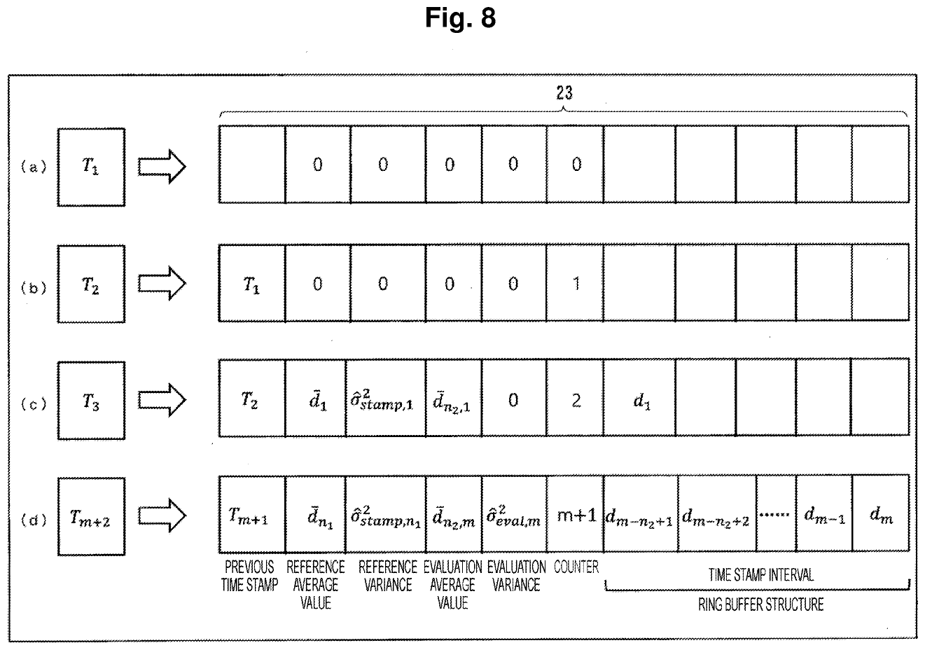

FIG. 8 is a diagram illustrating a method of storing data in the memory 23 of the sensor accommodating terminal 2 of the present embodiment. First, a sequential calculation method of the variance σₛₜₐₘₚ²-hat will be described.

Typically, the variance σₛₜₐₘₚ²-hat is calculated every time a targeted time stamp interval is obtained. However, while such a calculation method is simple and reliable, a large amount of memory is consumed, and a calculation amount cannot be ignored when a repeated operation is performed.

Therefore, the reference variance calculation unit 2021 of the present embodiment performs sequential calculation of updating a value using the current average value and variance when a new time stamp interval is obtained.

$$\begin{matrix}Equation 4 & \\ {\overline{d}}_{n + 1} = {\overline{d}}_{n} + \frac{{d}_{n + 1} - {\overline{d}}_{n}}{n + 1} & ( 4 )\end{matrix}$$

$${\hat{σ}}_{s tamp , n + 1}^{2} = \frac{n - 1}{n} {\hat{σ}}_{stamp , n}^{2} + \frac{1}{n} ( {d}_{n + 1} - \overline{{d}_{n + 1}} ) ( {d}_{n + 1} - \overline{{d}_{n}} ) \qquad ( 5 )$$

In Expressions (4) and (5), a dₙ-bar is an average value up to the n-th time stamp interval, and σ_{stamp,n}²-hat is a variance up to the n-th time stamp interval. The reference variance calculation unit 2021 uses an n+1-th time stamp interval dₙ₊₁ and the average value dₙ-bar to calculate an average value dₙ₊₁-bar up to the n+i-th time stamp interval as shown in Expression (4).

In addition, the reference variance calculation unit 2021 uses the variance σ_{stamp,n}²-hat and the average values dₙ-bar and dₙ₊₁-bar to calculate a variance σ_{stamp,n+}1²-hat up to the n+1-th time stamp interval as shown in Expression (5).

By performing the sequential calculation as described above, it is possible to perform necessary calculation without accumulating all the time stamp intervals d in the memory 23. Since the value required here is not the time stamp T itself but the time stamp interval d, the time stamp T stored in the memory 23 may be only the latest value for calculating the time stamp interval d.

In the example of FIG. 8, the time stamps T₁, T₂, T₃, . . . , Tₘ₊₂ are sequentially obtained. When the time stamp T₁ is obtained, the time stamp adding unit 201 stores the time stamp T₁ in the memory 23 as illustrated in (b) of FIG. 8. Then, the time stamp adding unit 201 sets a counter indicating the number of times of acquisition of the time stamp T to 1.

When the time stamp T₂ is obtained, the time stamp adding unit 201 updates the time stamp T₁ stored in the memory 23 to the time stamp T₂ as illustrated in (c) of FIG. 8. Then, the time stamp adding unit 201 sets a counter indicating the number of times of acquisition of the time stamp T to 2. Further, the time stamp adding unit 201 stores the time stamp interval d₁=T₂−T₁ in the memory 23. The reference variance calculation unit 2021 calculates an average value d₁-bar and a variance σ_{stamp,1}² from the time stamp interval d₁ and stores the average value d₁-bar and the variance σ_{stamp,1}² in the memory 23.

When the time stamp Tₙ₁₊₁ is obtained, the time stamp adding unit 201 updates the time stamp Tₙ₁ stored in the memory 23 to the time stamp Tₙ₁₊₁. Then, the time stamp adding unit 201 sets a counter indicating the number of times of acquisition of the time stamp T to n₁+1. Further, the time stamp adding unit 201 stores the time stamp interval dₙ₁=Tₙ₁₊₁−Tₙ₁ in the memory 23.

The reference variance calculation unit 2021 calculates an average value dₙ₁-bar using the average value dₙ₁₋₁-bar and the time stamp interval dₙ₁ stored in the memory 23 in the same manner as in Expression (4), and updates the average value dₙ₁₋₁-bar stored in the memory 23 to the dₙ₁-bar.

In addition, the reference variance calculation unit 2021 calculates a variance σ_{stamp,m}²-hat in the same manner as in Expression (5) using the variance σ_{stamp,n1-1}²-hat and the average value dₙ₁₋₁-bar stored in the memory 23, the newly calculated average value dₙ₁-bar, and time stamp interval dₙ₁, and updates the variance σ_{stamp,n1-1}²-hat stored in the memory 23 to the σ_{stamp,n1}²-hat.

Subsequently, the variance σₑᵥₐₗ²-hat cannot be calculated by sequential calculation of the variance σₛₜₐₘₚ²-hat in the foregoing expression. This is because when the new time stamp interval d is obtained, the oldest one of the n₂ time stamp intervals d has to be discarded, and the variance σₑᵥₐₗ²-hat has to be recalculated with the n₂ values including the new time stamp interval d. Therefore, it is necessary to always hold the n₂ time stamp intervals d in the memory 23.

On the other hand, since all the time stamp intervals d necessary for the calculation are held in the memory 23, the variance σₑᵥₐₗ²-hat may be calculated every time using all the time stamp intervals d. However, a calculation amount of O(n₂) is required for one calculation, and when the communication state is evaluated m times, a calculation amount of O(mn₂) is required, and the processing capability of the sensor accommodating terminal 2 becomes tight.

Therefore, the variance calculation unit 2022 of the present embodiment performs sequential calculation of updating the value using the current average value and variance when the new time stamp interval d is obtained. Thereby, the calculation amount can be reduced to O(m).

When m+1 time stamp intervals d are obtained after the calculation of the variance σₛₜₐₘₚ²-hat by the reference variance calculation unit 2021 (m≥n₂), the variance calculation unit 2022 calculates an average value d_{n2,m+1}-bar as shown in Expression (6) using the time stamp interval dₘ₊₁, the average value d_{n2,m}-bar stored in the memory 23, and the time stamp interval dₘ₊ₙ₂₊₁ stored in the memory 23, and updates the average value d_{n2,m}-bar stored in the memory 23 to the d_{n2,m+1}-bar. Expression (6) is an update expression of the average value of the latest n₂ time stamp intervals d.

$$\begin{matrix}Equation 5 & \\ {\overline{d}}_{{n}_{2} , m + 1} = {\overline{d}}_{{n}_{2} , m} - \frac{{d}_{m - {n}_{2} + 1}}{{n}_{2}} + \frac{{d}_{m + 1}}{{n}_{2}} ( m \geq {n}_{2} ) & ( 6 )\end{matrix}$$

Furthermore, the variance calculation unit 2022 calculates a variance σ_{eval,m+1}²-hat as shown in Expression (7) using the time stamp interval dₘ₊₁, the variance σ_{eval,m}²-hat, the average value d_{n2,m}-bar, and the time stamp interval dₘ₋ₙ₂₊₁ stored in the memory 23, and the newly calculated average value d_{n2,m+1}-bar, and updates the variance σ_{eval,m}²-hat stored in the memory 23 to the σ_{eval,m+1}²-hat.

$$\begin{matrix}Equation 6 & \\ {\hat{σ}}_{eval , m + 1}^{2} = {\hat{σ}}_{eval , m}^{2} + \frac{1}{{n}_{2} - 1} ( {d}_{m + 1} - {d}_{m - {n}_{2} + 1} ) ( {d}_{m + 1} - {\overline{d}}_{{n}_{2} , m + 1} + {d}_{m - {n}_{2} + 1} - {\overline{d}}_{{n}_{2} , m} ) & ( 7 )\end{matrix}$$

An area of the memory 23 in which the n₂ time stamp intervals d are stored has a ring buffer structure, and thus reading and writing from and to the memory 23 can be efficiently performed. One round of the ring buffer leads to the oldest data.

In the sequential calculation of the average value d_{n2,m+1}-bar of Expression (6), a value obtained by dividing the oldest time stamp interval dₘ₋ₙ₂₊₁ by n₂ is subtracted, and a value obtained by dividing the new time stamp interval dₘ₊₁ by n₂ is added. Before overwriting the old average value d_{n2,m}-bar stored in the memory 23 with the average value d_{n2,m+1}-bar, memory access can be performed without waste by reading the average value d_{n2,m}-bar from the memory 23. Similarly, before overwriting the old variance σ_{eval,m}²-hat stored in the memory 23 with the variance σ_{eval,m+1}²-hat, memory access can be performed without waste by reading the variance σ_{eval,m}²-hat from the memory 23.

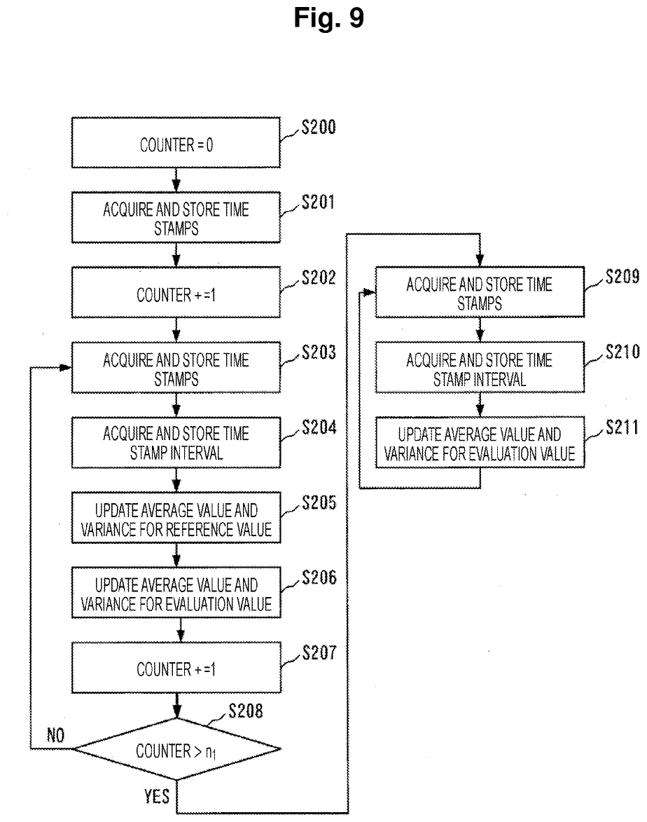

FIG. 9 is a flowchart illustrating operations of the time stamp adding unit 201, the variance calculation unit 2022, and the reference variance calculation unit 2021 according to the present embodiment.

The time stamp adding unit 201 resets the counter recorded in the memory 23 to 0 (step S200 in FIG. 9). The time stamp adding unit 201 acquires the time stamp T, updates the time stamp T stored in the memory 23 to the newly acquired time stamp T (step S201 in FIG. 9), and increments the counter by 1 (step S202 in FIG. 9).

The time stamp adding unit 201 acquires the time stamp T again, and updates the time stamp T stored in the memory 23 to the newly acquired time stamp T (step S203 in FIG. 9). In addition, the time stamp adding unit 201 stores the time stamp interval d in the memory 23 (step S204 in FIG. 9).

The reference variance calculation unit 2021 calculates the average value d-bar of the time stamp interval d and the variance σₛₜₐₘₚ²-hat as shown in Expressions (4) and (5), and stores the average value d-bar and the variance σₛₜₐₘₚ²-hat in the memory 23 (step S205 in FIG. 9).

The variance calculation unit 2022 calculates the average value d-bar of the time stamp interval d and the variance σₑᵥₐₗ²-hat as show in Expressions (6) and (7) and stores the average value d-bar and the variance σₑᵥₐₗ²-hat in the memory 23 (step S206 in FIG. 9).

The time stamp adding unit 201 increments the counter by 1 (step S207 in FIG. 9). The processing of steps S203 to S207 is repeatedly performed until the counter becomes larger than n₁.

The processing of steps S209, S210, and S211 is the same as that of steps S203, S204, and S206. Thereafter, the processing of steps S209 to S211 is repeatedly performed.

Note that, when the connection between the sensor terminal 1 and the sensor accommodating terminal 2 is completely disconnected, only the variance calculated as the reference value may be left, and the area other than the variance may be cleared, or all the memory areas used in the present embodiment may be cleared.

### Third Embodiment

Subsequently, a third embodiment of the present invention will be described. The present embodiment describes, in the first and second embodiments, an initialization method in the case where the communication environment is poor immediately after the start of connection between the sensor terminal and the sensor accommodating terminal, and a method of improving the real-time performance by speeding up the initialization processing.

In the first and second embodiments, it is assumed that the variances σₛₜₐₘₚ²-hat and σₑᵥₐₗ²-hat are calculated by receiving packets from one sensor terminal 1.

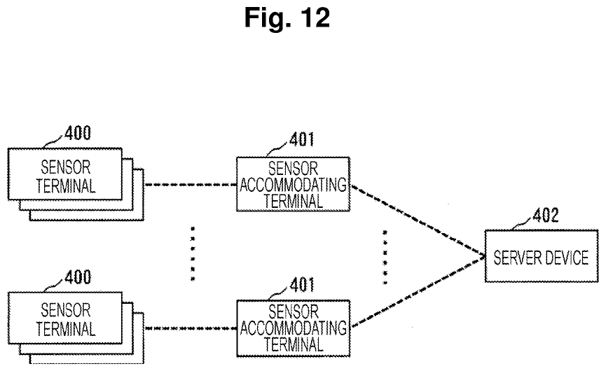

However, in the multi-sensor system as illustrated in FIG. 12, a plurality of sensor terminals are connected to one sensor accommodating terminal. In order to apply the first and second embodiments to the multi-sensor system, it is necessary to know the variance σₛₜₐₘₚ²-hat of the time stamp interval. However, when the communication environment is poor immediately after the start of connection between the sensor terminal 1 and the sensor accommodating terminal 2, packets cannot be received from the sensor terminal 1 (hereinafter referred to as a sensor terminal 1A) at a normal communication interval, so that the variance σₛₜₐₘₚ²-hat cannot be obtained.

In addition, the variance σₛₜₐₘₚ²-hat is affected by the error of the time stamp caused by the capability of the OS of the sensor accommodating terminal 2 and the clock accuracy. Therefore, the variance σₛₜₐₘₚ²-hat does not vary depending on each sensor terminal 1, but can be considered as a variable determined by the sensor accommodating terminal 2. That is, the variance σₛₜₐₘₚ²-hat is a common value in the sensor terminals 1 connected to the same sensor accommodating terminal 2.

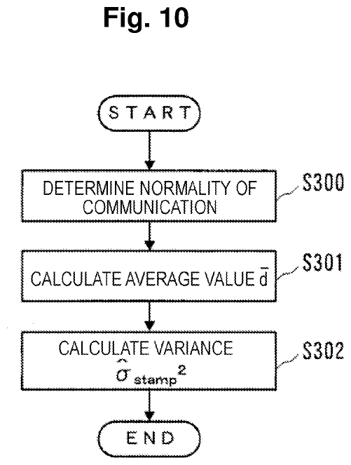

Therefore, the reference variance calculation unit 2021 of the sensor accommodating terminal 2 calculates the variance σₛₜₐₘₚ²-hat on the basis of the time stamp interval obtained by receiving packets from one or more sensor terminals 1 that can normally communicate other than the sensor terminal 1A. FIG. 10 is a flowchart illustrating an operation of the reference variance calculation unit 2021 according to the present embodiment.

The reference variance calculation unit 2021 determines normality of communication between one or more sensor terminals 1 connected to the sensor accommodating terminal 2 and the sensor accommodating terminal 2 (step S300 in FIG. 10).

As an index for determining the normality of communication, a reception interval can be used. Specifically, the reference variance calculation unit 2021 may determine that the communication state with the sensor terminal 1 is abnormal when the difference between the reception interval of the packet from the sensor terminal 1 and the predefined transmission cycle T_{send} of the sensor terminal 1 exceeds the defined value, and may determine that the communication state with the sensor terminal 1 is normal when the difference between the reception interval of the packet and the transmission cycle T_{send} is equal to or less than the defined value.

The reference variance calculation unit 2021 calculates the average value d-bar of the time stamp intervals d similarly to the first and second embodiments (step S301 in FIG. 10). At this time, the reference variance calculation unit 2021 excludes, from the calculation of the average value d-bar, the time stamp interval d obtained by receiving packets from the sensor terminal 1 in which the communication state with the sensor accommodating terminal 2 is determined to be abnormal in the processing of step S300.

Then, the reference variance calculation unit 2021 calculates the variance σₛₜₐₘₚ²-hat of the time stamp interval d similarly to the first and second embodiments (step S302 in FIG. 10). At this time, the reference variance calculation unit 2021 excludes, from the calculation of the variance σₛₜₐₘₚ²-hat, the time stamp interval d obtained by receiving packets from the sensor terminal 1 in which the communication state with the sensor accommodating terminal 2 is determined to be abnormal in the processing of step S300.

Thus, in the present embodiment, the disconnection determination can be performed regardless of the communication environment at the time of connection.

Furthermore, in the present embodiment, when the average value d-bar and the variance σₛₜₐₘₚ²-hat are calculated on the basis of the time stamp interval obtained by receiving packets from a plurality of sensor terminals 1 that can normally communicate, the time required for the initialization processing can be shortened, and the real-time performance can be improved.

There are S (S is an integer of 2 or more) sensor terminals 1 that can normally communicate, and a predefined transmission cycle of each sensor terminal 1 is denoted by T_{send}ⁱ, and the number of data used for initialization processing is denoted by K (K is an integer of 2 or more). When the transmission cycles T_{send}ⁱ are all the same value T_{send}, a time T required for the initialization processing is as follows.

$$\begin{matrix}Equation 7 & \\ τ = ⌈ \frac{K}{S} ⌉ {T}_{send} & ( 8 )\end{matrix}$$

Furthermore, when the transmission cycles T_{send}ⁱ of the sensor terminals 1 are different from each other, the time T required for the initialization processing is as follows.

$$\begin{matrix}Equation 8 & \\ τ \approx \frac{K}{{\sum }_{t = 1}^{S} \frac{1}{{T}_{send}^{i}}} & ( 9 )\end{matrix}$$

In this way, in the present embodiment, the initialization processing can be speeded up, and the time until the disconnection determination is performed can be shortened.

When the transmission cycles T_{send}ⁱ are all the same value T_{send}, it is possible to collect initialization data most efficiently by setting the number of data K to a multiple of the number S of the sensor terminals 1.

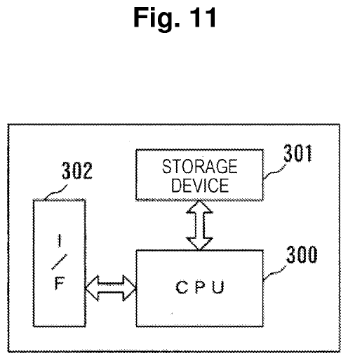

The control unit 20 of the sensor accommodating terminal 2 described in the first to third embodiments can be realized by a computer including a CPU or an MCU, a storage device, and an interface, and a program for controlling these hardware resources. A configuration example of this computer is illustrated in FIG. 11.

The computer includes a CPU 300, a storage device 301, and an interface device (I/F) 302. The wireless circuit 21, the communication circuit 22, the clock unit 24, and the like are connected to the I/F 302. In such a computer, the disconnection determination program for realizing the disconnection determination method according to embodiments of the present invention is stored in the storage device 301. The CPU 300 executes the processes described in the first to third embodiments according to the program stored in the storage device 301. The program may also be provided via a network. The control unit 10 of the sensor terminal 1 can also be realized by a computer.

### INDUSTRIAL APPLICABILITY

Embodiments of the present invention can be applied to a multi-sensor system that accommodates a large variety of sensors.

### REFERENCE SIGNS LIST

1 Sensor terminal
2 Sensor accommodating terminal
10, 20 Control unit
11, 21 Wireless circuit
12 Sensor circuit
13, 23 Memory
22 Communication circuit
24 Clock unit
100, 200 Communication control unit
201 Time stamp adding unit
202 Disconnection determination unit
2020 Time stamp interval input unit
2021 Reference variance calculation unit
2022 Variance calculation unit
2023 Evaluation value calculation unit
2024 Equal variance determination unit.

1.-9. (canceled)

10. A sensor accommodating terminal comprising:
a communication controller configured to control communication with a sensor terminal configured to wirelessly transmit a packet storing sensor data;
a time stamp adding circuit configured to acquire a time stamp of a reception time of the packet received from the sensor terminal;
a memory configured to store the time stamp, a first plurality of time stamp intervals, and a second plurality of time stamp intervals;
a first variance calculator configured to calculate a first variance of the first plurality of time stamp intervals, each of the first plurality of time stamp intervals being a time interval between two consecutive time stamps corresponding to two consecutive packets storing sensor data;
a second variance calculator configured to calculate a second variance of the second plurality of time stamp intervals, each of the second plurality of time stamp intervals being a time interval between two consecutive time stamps corresponding to two consecutive packets storing sensor data obtained after calculating of the first variance;
an evaluation value calculator configured to calculate a ratio of the second variance to the first variance as an evaluation value; and
an equal variance determination circuit configured to determine whether a reception interval of the packet is normal or abnormal by equal variance determination of the evaluation value.

11. The sensor accommodating terminal according to claim 10, further comprising a clock configured to measure time, wherein:
the time stamp adding circuit is configured to acquire the time stamp based on time information of the clock upon receiving the packet from the sensor terminal;
the first variance calculator is configured to calculate the first variance based on a first specified number of the first plurality of time stamp intervals;
the second variance calculator is configured to calculate the second variance based on a second specified number of the second plurality of time stamp intervals;
the equal variance determination circuit is configured to determine whether the reception interval of the packet is normal or abnormal by comparing the evaluation value with a critical value corresponding to a significance level of an F distribution; and
the communication controller is configured to disconnect a connection to the sensor terminal when the reception interval of the packet is determined to be abnormal.

12. The sensor accommodating terminal according to claim 11, wherein:
the time stamp adding circuit is configured to store the time stamp and the second plurality of time stamp intervals corresponding to the second specified number in the memory; and
an area of the memory in which the second plurality of time stamp intervals corresponding to the second specified number are stored has a ring buffer structure.

13. The sensor accommodating terminal according to claim 12, wherein:
the first variance calculator is configured to sequentially calculate an average value by using a newly obtained time stamp interval and an average value of the first plurality of time stamp intervals up to an immediately preceding time to store the average value in the memory, and sequentially calculate the first variance by using the newly obtained time stamp interval, the first variance up to an immediately preceding time, the average value up to an immediately preceding time, and the newly calculated average value to store the first variance in the memory; and
the second variance calculator is configured to calculate the second variance based on the second specified number of the second plurality of time stamp intervals newly obtained after calculation of the first variance.

14. The sensor accommodating terminal according to claim 13, wherein:
the second variance calculator is configured to sequentially calculate an average value by using the newly obtained time stamp interval, an average value of the second plurality of time stamp intervals up to an immediately preceding time, and an oldest time stamp interval stored in the memory to store the average value in the memory, and sequentially calculate the second variance by using the newly obtained time stamp interval, the second variance up to an immediately preceding time, the average value up to an immediately preceding time, the oldest time stamp interval stored in the memory, and the newly calculated average value to store the second variance in the memory.

15. The sensor accommodating terminal according to claim 10,
wherein the first variance calculator is configured to exclude, from calculation of the first variance, a time stamp interval obtained by receiving packets from the sensor terminal in which a communication state with the sensor accommodating terminal is determined to be abnormal, and calculates the first variance based on a time stamp interval obtained by receiving packets from one or more sensor terminals in which a communication state with the sensor accommodating terminal is determined to be normal.

16. The sensor accommodating terminal according to claim 10,
wherein the first variance calculator is configured to calculate the first variance based on a time stamp interval obtained by receiving packets from a plurality of sensor terminals.

17. A disconnection determination method for determining whether to disconnect a connection between a sensor terminal and a sensor accommodating terminal in a sensor system including the sensor terminal configured to wirelessly transmit a packet storing sensor data and the sensor accommodating terminal configured to transmit the sensor data included in the packet to a host device, the disconnection determination method comprising:
a first step of acquiring, by the sensor accommodating terminal, a time stamp of a reception time of a packet received from the sensor terminal;
a second step of storing, by the sensor accommodating terminal, the time stamp, a first plurality of time stamp intervals, and a second plurality of time stamp intervals;
a third step of calculating, by the sensor accommodating terminal, a first variance of the first plurality of time stamp intervals, each of the first plurality of time stamp intervals being a time interval between two consecutive time stamps corresponding to two consecutive packets storing sensor data;
a fourth step of calculating, by the sensor accommodating terminal, a second variance of the second plurality of time stamp interval, each of the second plurality of time stamp intervals being a time interval between two consecutive time stamps corresponding to two consecutive packets storing sensor data newly obtained after calculation of the first variance;
a fifth step of calculating, by the sensor accommodating terminal, a ratio of the second variance to the first variance as an evaluation value; and
a sixth step of determining, by the sensor accommodating terminal, whether a reception interval of the packet is normal or abnormal by equal variance determination of the evaluation value.

18. The disconnection determination method according to claim 17, wherein:
the first step comprises acquiring the time stamp based on time information of a clock upon receiving the packet from the sensor terminal;
the third step comprises calculating the first variance based on a first specified number of the first plurality of tamp intervals;
the fourth step comprises calculating the second variance based on a second specified number of the second plurality of time stamp intervals;
the sixth step comprises determining whether the reception interval of the packet is normal or abnormal by comparing the evaluation value with a critical value corresponding to a significance level of an F distribution; and
the method further comprises a seventh step of disconnecting the connection to the sensor terminal when the reception interval of the packet is determined to be abnormal.

19. The disconnection determination method according to claim 18, wherein:
the second step comprises storing the second plurality of time stamp intervals corresponding to the second specified number in a ring buffer structure.

20. The disconnection determination method according to claim 19, wherein:
the third step comprises sequentially calculating an average value by using a newly obtained time stamp interval and an average value of the first plurality of time stamp intervals up to an immediately preceding time to store the average value, and sequentially calculate the first variance by using the newly obtained time stamp interval, the first variance up to an immediately preceding time, the average value up to an immediately preceding time, and the newly calculated average value to store the first variance; and
the fourth step comprises calculating the second variance based on the second specified number of the second plurality of time stamp intervals newly obtained after calculation of the first variance.

21. The disconnection determination method according to claim 20, wherein:
the fourth step comprises sequentially calculating an average value by using the newly obtained time stamp interval, an average value of the second plurality of time stamp intervals up to an immediately preceding time, and an oldest stored time stamp interval to store the average value, and sequentially calculate the second variance by using the newly obtained time stamp interval, the second variance up to an immediately preceding time, the average value up to an immediately preceding time, the oldest stored time stamp interval, and the newly calculated average value to store the second variance.

22. The disconnection determination method according to claim 17, wherein:
the third step comprises excluding, from calculation of the first variance, a time stamp interval obtained by receiving packets from the sensor terminal in which a communication state with the sensor accommodating terminal is determined to be abnormal, and calculates the first variance based on a time stamp interval obtained by receiving packets from one or more sensor terminals in which a communication state with the sensor accommodating terminal is determined to be normal.

23. The disconnection determination method according to claim 17, wherein:
the third step comprises calculating the first variance based on a time stamp interval obtained by receiving packets from a plurality of sensor terminals.

24. A disconnection determination program causing a computer to execute each step according to claim 17.
